(19) United States
(12) Patent Application Publication
(10) Pub. No.: US 2006/0031100 A1
(43) Pub. Date: Feb. 9, 2006

(54) Method of providing per dose delivery of veterinary oncology chemotherapy and immunotherapy agents and nutritional formulations

(76) Inventor: Brian J. Huber, Rockwall, TX (US)

Correspondence Address: Martin G. Ozinga;Phillips McFall McCaffrey McVay & Murrah, P.C., One Leadership Square, 12th Floor, 211 N. Robinson Ave., Oklahoma City, OK, 73102, US

(21) Appl. No.: 11/243,806

(22) Filed: Oct. 5, 2005

Related U.S. Application Data
(63) Continuation of application No. 09/707,510, filed on Nov. 7, 2000, now abandoned.

(51) Int. Cl. G06Q 50/00

(52) U.S. Cl. 705/2; 705/39

(57) ABSTRACT

A method of providing per dose delivery of veterinary oncology chemotherapy and immunotherapy agents and nutritional formulations provides such delivery without waste and with enhanced convenience. In a described embodiment, the method includes input by a treating veterinarian of a diagnosis and characteristics of a specific patient. The diagnosis may alternatively be input by an oncology specialist with whom the treating veterinarian consults. A service provider generates a recommended treatment protocol, including a recommended dose of an oncology treatment agent. Upon acceptance, an order is transmitted to a centralized dispensing facility, which dispenses or formulates a dose of the treatment agent and delivers it to the treating veterinarian.

### BACKGROUND

The present invention relates generally to the dispensing of medications and, in an embodiment described herein, more particularly provides a method of providing per dose delivery of veterinary oncology chemotherapy and immunotherapy agents and nutritional formulations.

Chemotherapy and immunotherapy agents used in the treatment of veterinary oncology patients are frequently the same as those used in the treatment of human patients. However, due to the generally smaller size of veterinary patients, and other factors, a dose of such an agent in a veterinary patient's oncology treatment protocol is virtually always smaller than a dose of the same agent in a human patient's oncology treatment protocol.

Due to the far greater demand for chemotherapy and immunotherapy agents for treating human patients, these agents are typically packaged according to usual doses in human patient oncology treatment protocols. This means that, when a dose of a chemotherapy or immunotherapy agent is ordered for a veterinary patient, the dose is usually dispensed from a container which contains a much larger quantity of the agent.

Since there has heretofore been no method of providing per dose delivery of a veterinary oncology chemotherapy or immunotherapy agent, a veterinarian must order the container of the agent and dispense from it the dose needed for the veterinary patient. The remainder of the chemotherapy or immunotherapy agent in the container may go to waste, and so the veterinarian must charge the veterinarian patient's owner for the entire container, even though only a portion of the agent in the container has been dispensed for the patient.

This situation has existed for many years. It is, however, very inconvenient and uneconomical for both the veterinarian and the veterinary patient's owner. The veterinarian must order and inventory excess quantities of chemotherapy and immunotherapy agents, and must charge the owner excessively for the veterinary patient's oncology treatment protocol. The unfortunate consequence is that the patient's owner must pay for more chemotherapy and/or immunotherapy agent than is needed to treat the patient.

A similar situation exists in providing nutritional therapy for veterinary patients. For example, what is known as total parenteral nutrition is not readily available at this time for veterinary patients. This is due to the fact that no method presently exists for providing per dose delivery of nutritional formulations.

From the foregoing, it can be seen that it would be quite desirable to provide a method of providing per dose delivery of veterinary oncology chemotherapy and immunotherapy agents and nutritional formulations which does not have the inefficiencies and uneconomical characteristics of the prior method. It is accordingly an object of the present invention to provide such a method.

### SUMMARY

In carrying out the principles of the present invention, in accordance with an embodiment thereof, a method is provided which enables per dose delivery of a veterinary oncology chemotherapy or immunotherapy agent or a nutritional formulation to a veterinary patient, without the need for a veterinarian to order a container containing an excess quantity of the chemotherapy or immunotherapy agent and dispense the dose therefrom, or for a veterinarian to order and combine various quantities of nutritional components to produce a nutritional formulation.

In one aspect of the present invention, a method of delivering a dose of a veterinary oncology treatment agent utilizes a computer network, such as the World Wide Web, Internet, a telecommunications network, etc., to facilitate delivery of the dose. After a veterinarian has diagnosed a patient, a dose of an oncology treatment agent is ordered via the computer network from a centralized facility, such as a pharmacy, where the dose is dispensed. The dose is delivered to the veterinarian, without the veterinarian having to receive an excess quantity of the treatment agent.

In another aspect of the invention, the veterinarian may consult with an oncology specialist, who then makes various inputs to the computer network, whereupon a calculation is made of a recommended dosage for the specific patient. For example, the computer network may have stored thereon a program which calculates a recommended dose of a specific oncology treatment agent in response to input thereto of specific information regarding a particular patient. The recommended dose is transmitted to the veterinarian via the network, at which point the veterinarian may accept, decline or modify the recommendation.

If the recommendation is accepted, or modified and then accepted in its modified form, a financial transaction may be performed prior to the dose being ordered. For example, a previously registered and verified credit account of the veterinarian may be processed to charge the veterinarian for the dose of the chemotherapy agent prior to the dose being ordered.

Dispensing of the chemotherapy or immunotherapy agent or nutritional formulation is preferably performed at a remote centralized facility connected to the same, or another, computer network. The chemotherapy or immunotherapy agent or nutritional formulation components are inventoried at the facility in appropriate quantities. When an order for a specific dose of the chemotherapy or immunotherapy agent or the nutritional formulation is received via the computer network, the dose is dispensed from the facility's inventory.

Since the facility serves a large client base via the computer network, the chemotherapy or immunotherapy agent or nutritional formulation may be dispensed on a per dose basis with a greatly reduced risk that a remaining portion of an agent or nutritional component in a container will be wasted. Therefore, the veterinarian may be charged only for the dose ordered, and not for the entire container, of the agent or component.

In still another aspect of the invention, the method is uniquely suited for supplying ancillary equipment along with the per dose delivery of the chemotherapy or immunotherapy agent or nutritional formulation. This ancillary equipment may include safety gear required by OSHA for use during administration of the agent or formulation. For example, safety glasses, chemo safety gloves, a chemo safety gown, a mask, etc. may be supplied with the delivery. The ancillary equipment may include any necessary syringe needles and infusion sets supplied with the delivery. The proper infusion sets delivered may be based upon whether the patient has a vascular access port or a cephalic catheter in place. Preferably, all nutritional formulations will be delivered with appropriate infusion sets, thereby limiting unnecessary handling of the sterile solutions. Delivery of the ancillary equipment removes the need for veterinarians to separately order additional specialty supplies for oncology services, and assures the safety of the veterinarian staff in administering the agents.

These and other features, advantages, benefits and objects of the present invention will become apparent to one of ordinary skill in the art upon careful consideration of the detailed description of a representative embodiment of the invention hereinbelow and the accompanying drawings.

### BRIEF DESCRIPTION OF THE DRAWINGS

FIG. 1 is a flow chart schematically illustrating a method embodying principles of the present invention;

FIG. 2 is a flow chart schematically illustrating a financial transaction method which may be used in the method of FIG. 1;

FIG. 3 is a flow chart schematically illustrating a dispensing method which may be used in the method of FIG. 1; and

FIG. 4 is schematic illustration of a system for implementing the method of FIG. 1.

### DETAILED DESCRIPTION

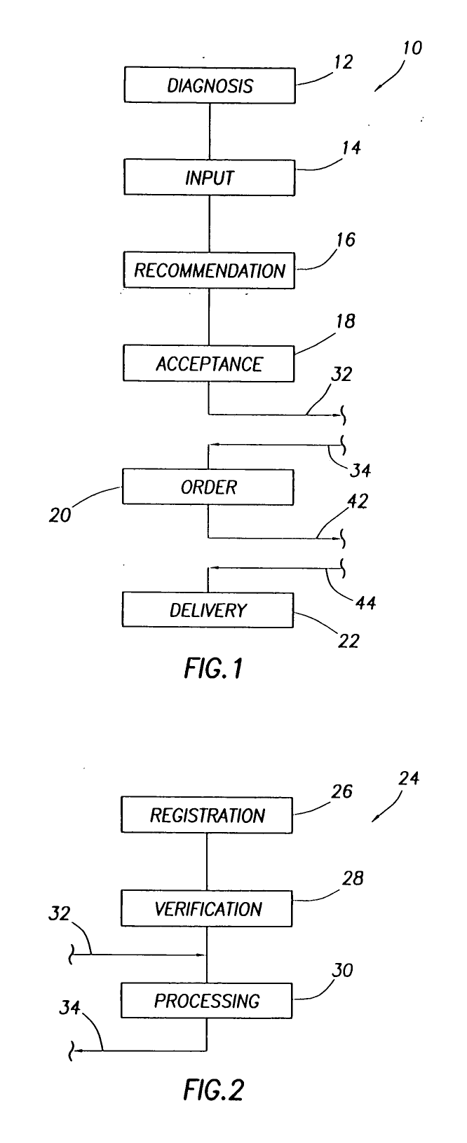

Representatively illustrated in FIG. 1 is a method 10 of providing per dose delivery of veterinary oncology chemotherapy agents, which method embodies principles of the present invention. A preferred embodiment of the method 10 is described herein, but it is to be clearly understood that many variations may be made in the method, without departing from the principles of the invention.

For convenience and clarity of description, only per dose delivery of a chemotherapy agent is described herein, it being understood that the method 10 may also be used for per dose delivery of immunotherapy agents and nutritional formulations. As used herein, the term “oncology treatment agent” is used to indicate a chemotherapy agent, immunotherapy agent or nutritional formulation used in a treatment protocol for a veterinary oncology patient.

Initially, a veterinarian (preferably, an oncology specialist) makes a diagnosis (step 12 in the method 10) for a specific veterinary patient. The veterinarian then makes an input (step 14) to a computer network. This input may include a variety of parameters specific to the particular patient to be treated. For example, the input in step 14 may include the diagnosis and the breed, weight, age, gender, etc., of the patient. Where nutritional therapy is indicated, the input would preferably further include blood laboratory values for determining the patient's nutritional requirements.

As used herein, the term “veterinarian” is used to indicate one or more medical professionals certified to practice medicine for veterinary patients. The term may be used in the aggregate to indicate a business entity, such as a veterinary clinic employing one or more veterinarians, etc. Preferably, where a diagnosis and a treatment protocol for an oncology patient are to be determined, the veterinarian is an oncology specialist, or the veterinarian consults with an oncology specialist for determining the diagnosis and treatment protocol.

The computer network has stored thereon a program which generates a recommendation (step 16) as to a treatment protocol for the patient. This recommendation is, for example, based on generally accepted practice in the veterinary oncology field for a patient having the characteristics of the patient input in step 14 above. In the method 10, the recommendation includes a specific dose of a chemotherapy agent as a part of the treatment protocol.

In step 18, the recommendation is transmitted via the computer network to the veterinarian. The veterinarian reviews the recommendation, including the recommended chemotherapy agent dose, and may accept or decline the recommendation, or accept the recommendation in modified form, via the computer network. The veterinarian may be presented with a quoted charge for the chemotherapy agent dose at the time the recommendation is transmitted to the veterinarian.

If the recommendation is accepted, in its original or modified form, an order is placed for the chemotherapy agent dose in step 20. Preferably, the order is transmitted via the computer network to a remote centralized dispensing facility which maintains an inventory of the chemotherapy agent.

The dispensing facility dispenses a dose of the chemotherapy agent and delivers the dose to the veterinarian in step 22. The veterinarian receives only the quantity of the chemotherapy agent needed for the recommended dose for the patient, and does not have to inventory any excess quantity of the chemotherapy agent. The veterinarian also does not have to charge the patient's owner for any quantity of the chemotherapy agent greater than that required for the recommended dose.

Referring additionally now to FIG. 2, an example of a financial transaction method 24 which may be used in the method 10 is representatively illustrated. The method 24 is for posting a charge to a credit account upon acceptance of the recommendation in step 18 of the method 10 described above. However, it is to be clearly understood that other means of performing a financial transaction for the method 10 may be used, without departing from the principles of the invention. For example, the veterinarian may be invoiced, or the chemotherapy agent dose may be delivered C.O.D., etc. Thus, any financial transaction method may be used in the method 10.

In an initial step 26 of the method 24, a veterinarian registers at least in part by providing information, including, for example, identification of a credit account, such as a credit card number. This registration step 26 may be performed either prior to a diagnosis of a particular patient, or subsequent thereto. Preferably, the veterinarian registers in advance of diagnosis of a particular patient, so that when the diagnosis is made, an order for a recommended dose of an appropriate chemotherapy agent may be placed and delivered without delay.

After the veterinarian has registered in step 26, the credit account information is verified in step 28 of the method 24. This step verifies that the credit account information is correct, the account is active, etc. As with the registration step 26, this verification step 28 is preferably performed prior to a specific diagnosis, so that delay may be avoided when an order for a chemotherapy agent dose is to be made.

Actual processing of a charge to a veterinarian's credit account in step 30 of the method 24 is performed when the recommendation is accepted by the veterinarian. This is illustrated in FIGS. 1 and 2 by the arrows indicated by reference numbers 32, 34. Thus, when the recommendation is transmitted to the veterinarian via the computer network in step 18, and the veterinarian accepts the original recommendation, or modifies the recommendation and then accepts the modified recommendation, this acceptance is transmitted via the computer network as indicated by the arrow 32.

Processing of an appropriate charge to the veterinarian's credit account is performed in step 30 of the method 24. This processing may be performed at a remote location, such as by transmitting information regarding the charge to be made to a credit card issuer. Typically, such a credit card issuer will transmit a reply verifying that the charge has been made. Once the processing step 30 has been completed, the order is placed for the chemotherapy agent dose in step 20 of the method 10, as indicated by arrow 34.

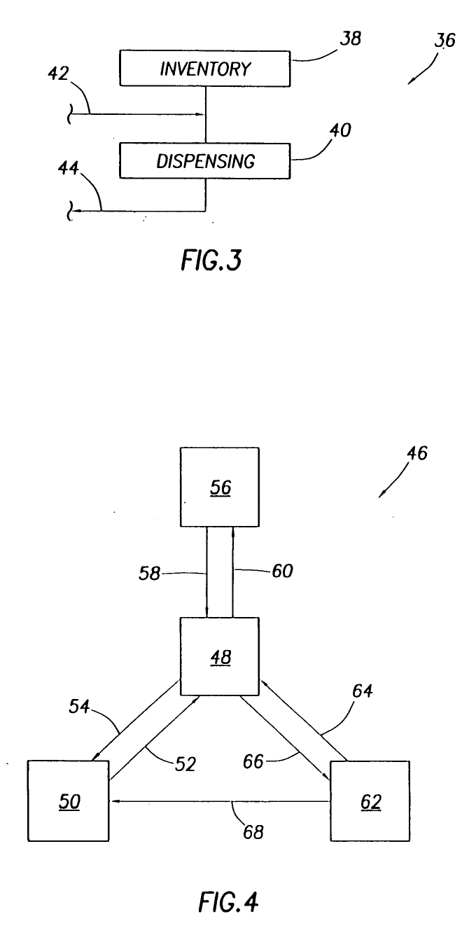

Referring additionally now to FIG. 3, an example of a dispensing method 36 which may be used in the method 10 is representatively illustrated. The method 36 utilizes a centralized or regionalized (i.e., centralized with respect to a particular region) facility which is able to dispense chemotherapy agents to a large number of veterinarians utilizing the method 10. In this way, the facility is able to take advantage of a relatively large volume of orders, thereby reducing the likelihood that any significant quantity of chemotherapy agent remaining in a container after dispensing a dose for a veterinary patient will be unused.

In step 38 of the method 36, the facility procures an inventory of the chemotherapy agent. This step is, of course, preferably performed prior to the time the recommendation for a dose of the chemotherapy agent is made in step 16 of the method 10, and should at least be performed prior to the order being placed in step 20 of the method 10, to ensure that the chemotherapy agent is available for immediate dispensing when the dose is ordered.

In step 40 of the method 36, the dose of the chemotherapy agent is dispensed at the facility. The dispensing step 40 is performed in response to receipt of the order in step 20 of the method 10, as indicated by the arrow 42. Preferably, the order is transmitted via the computer network to minimize any delay between the ordering and dispensing steps 20, 40.

Where a nutritional formulation is to be dispensed, the facility maintains an inventory of the various nutritional components, and then combines appropriate quantities of the components to produce a dose of the nutritional formulation.

Once the chemotherapy agent dose has been dispensed, it is delivered to the veterinarian, as indicated by the arrow 44. Upon delivery (step 22 in the method 10), the veterinarian may treat the patient with the appropriate dose. Due to the unique advantages of the method 10 described above, the veterinarian is permitted to treat the patient with the appropriate dose of the chemotherapy agent without having to order and receive an excessive amount of the chemotherapy agent, and without having to charge the patient's owner for the excess.

The method 10 is, in addition, preferably used for supplying ancillary equipment along with the per dose delivery of the chemotherapy or immunotherapy agent or nutritional formulation in step 22. This ancillary equipment may include safety gear required by OSHA for use during administration of the agent or formulation. For example, safety glasses, chemo safety gloves, a chemo safety gown, a mask, etc. may be supplied with the delivery. The ancillary equipment may include any necessary needles and infusion sets supplied with the delivery. The proper infusion sets delivered may be based upon whether the patient has a vascular access port or a cephalic catheter in place, which information may be supplied in the input step 14. Preferably, all nutritional formulations will be delivered with appropriate infusion sets, thereby limiting unnecessary handling of the sterile solutions. Delivery of the ancillary equipment removes the need for veterinarians to separately order additional specialty supplies for oncology services, and assures the safety of the veterinarian staff in administering the agents.

Referring additionally now to FIG. 4, a system 46 for implementing the method 10 is representatively illustrated. The system 46 embodies principles of the present invention, but it is to be clearly understood that other systems may be used for implementing the method 10, and systems implementing other methods may alternatively be used.

Preferably, a server 48 or other computer is at the heart of the system 46, and is maintained by a service provider. The server 48 may in addition have various computers and/or terminals connected thereto, either directly or via a network. The server 48 and its connected computers and/or terminals (if any), collectively referred to hereinafter as the “server”, preferably performs all of the functions in the method 10 described above of communicating with the veterinarian, computing a recommended dose, communicating with a credit account issuer, communicating with a dispensing facility, maintaining a transactional database, etc. However, other systems, computers, etc. may perform one or more of these functions.

A veterinarian having a computer or terminal 50, for example, inputs a diagnosis, patient characteristics and credit account information to the server 48, as illustrated by the arrow indicated by reference number 52 in FIG. 4. These inputs are preferably communicated by a computer network, such as the Internet. Alternatively, the veterinarian treating the specific patient may interact via the computer network with a specialist (e.g., an oncology specialist) who consults for the service provider. The specialist and/or treating veterinarian may make the diagnosis and determine the treatment protocol based on this consultation.

The server 48 is programmed with software that, for example, computes a recommended dose of a chemotherapy agent, automates verification of the credit account, automates processing of an order, including a charge to the credit account, communicates order details to the dispensing facility, communicates order status to the veterinarian, etc.

Communications from the server 48 to the veterinarian's computer 50 is illustrated in FIG. 4 by the arrow 54. Communications between the server 48 and a credit account issuer's computer or terminal 56 are illustrated in FIG. 4 by the arrows 58, 60. Communications between the server 48 and a dispensing facility's computer or terminal 62 are illustrated in FIG. 4 by the arrows 64, 66. All of these communications are preferably via a computer network, such as the Internet. Note that any of the above-described computers 50, 56, 62 may itself be a computer network server.

Once the order has been filled, that is, when the dispensing facility has dispensed the appropriate dose of the chemotherapy agent, the dose is delivered to the veterinarian. This delivery step is represented in FIG. 4 by the arrow 68 (however, the chemotherapy agent is delivered from the dispensing facility to the veterinarian, not from the dispensing facility's computer 62 to the veterinarian's computer 50).

Of course, a person skilled in the art would, upon a careful consideration of the above description of a representative embodiment of the invention, readily appreciate that many modifications, additions, substitutions, deletions, and other changes may be made to this specific embodiment, and such changes are contemplated by the principles of the present invention. For example, the veterinarian could communicate with the service provider by voice telephone, the dispensing facility could communicate with the credit account issuer, so that a charge is processed upon delivery of the chemotherapy agent dose, etc. Accordingly, the foregoing detailed description is to be clearly understood as being given by way of illustration and example only, the spirit and scope of the present invention being limited solely by the appended claims.

What is claimed is:

1. A method of providing per dose delivery of a veterinary oncology treatment agent, the method comprising the steps of:
interconnecting a service provider's computer and a veterinarian's computer via a computer network;
diagnosing a veterinarian patient by a veterinarian;
inputting characteristics of the veterinary patient from the veterinarian's computer to the service provider's computer via the computer network;
communicating details of a veterinary oncology treatment agent dose for treatment of the veterinary patient from the service provider's computer to the veterinarian's computer via the computer network;
placing an order for the veterinary oncology treatment agent dose in response to a communication from the veterinarian's computer to the service provider's computer via the computer network;
dispensing the veterinary oncology treatment agent dose at a remote dispensing facility; and
delivering the veterinary oncology treatment agent dose directly from the dispensing facility to the veterinarian.

2. The method according to claim 1, wherein the delivering step further comprises delivering the veterinary oncology treatment agent dose accompanied by ancillary equipment.

3. The method according to claim 2, wherein in the delivering step, the ancillary equipment comprises safety equipment for administering the veterinary oncology treatment agent dose.

4. The method according to claim 2, wherein in the delivering step, the ancillary equipment comprises a selected one of syringe needles and infusion sets.

5. The method according to claim 1, wherein the order placing step is performed in response to the communication from the veterinarian's computer to the service provider's computer, which communication is an acceptance of a recommendation for the veterinary oncology treatment agent dose.

6. The method according to claim 5, wherein the recommendation is generated by the service provider's computer in response to the step of inputting characteristics of the veterinary patient from the veterinarian's computer to the service provider's computer.
